(19) United States
(12) Patent Application Publication
(10) Pub. No.: US 2025/0296845 A1
(43) Pub. Date: Sep. 25, 2025

(54) METHOD FOR PRODUCTION OF BLUE AMMONIA

(71) Applicant: Topsoe A/S, Kgs. Lyngby (DK)

(72) Inventors: Per Juul Dahl, Vedbæk (DK); Ameet Kakoti, Kokkedahl (DK)

(73) Assignee: Topsoe A/S, Kgs. Lyngby (DK)

(21) Appl. No.: 18/862,106

(22) PCT Filed: May 3, 2023
(86) PCT No.: PCT/EP2023/061637

§ 371 Date: Oct. 31, 2024

(30) Foreign Application Priority Data
May 5, 2022 (DK) PA202200424

(51) Int. Cl. C01C 1/04; C01B 3/48

(52) U.S. Cl. CPC C01C 1/0405; C01B 3/48; C01B 2203/0205; C01B 2203/0283; C01B 2203/04; C01B 2203/047; C01B 2203/0475; C01B 2203/048; C01B 2203/0495; C01B 2203/068; C01B 2203/1235; C01B 2203/14

(57) ABSTRACT

The present invention provides a method and system for producing blue ammonia, providing for a higher percentage of carbon capture. The method and system of the invention may be used in any ammonia plant.

### FIELD OF INVENTION

The present invention provides a method and system for producing blue ammonia, providing for a higher percentage of carbon capture. The method and system of the invention may be used in any ammonia plant.

### BACKGROUND ART

Blue ammonia is a fossil fuel-based product produced with minimum emission of CO₂ to the atmosphere. It is seen as a transition product between conventional fossil fuel-based ammonia and green ammonia produced from green or renewable power and air. The CO₂ resulting from a blue ammonia production shall be stored permanently or converted into other chemicals. The main steps for producing blue ammonia are essentially the same as for producing conventional fossil fuel-based ammonia, the difference being that more of the carbon stemming from the carbon fuel is captured, providing a possibility for further processing.

The key here is that the blue ammonia does not release any carbon dioxide when used as fertilizer or burned. Currently available technology traps nearly all CO₂ generated during the conversion process making this fuel one of the first carbon free fuel options for mass use. Blue ammonia is considered an environmental friendly product which can be used until sufficient renewable or green power is available for producing green ammonia.

Document WO2018/149641 discloses a process for the synthesis of ammonia from natural gas comprising conversion of a charge of desulphurized natural gas and steam, with oxygen-enriched air or oxygen, into a synthesis gas (11), and treatment of the synthesis gas (11) with shift reaction and decarbonation, wherein a part of the CO₂-depleted synthesis gas, obtained after decarbonation, is separated and used as fuel fraction for one or more furnaces of the conversion section, and the remaining part of the gas is used to produce ammonia.

The present invention is different from the process disclosed in that document in that the by the method of the invention off-gases from different process steps are utilized as fuel in a preheating system with a number fired preheater for preheating a hydrocarbon feed stock together with carbon capture from at least one preheater, which enables the use of a more carbon depleted fuel, thereby achieving a higher carbon recovery (more than 98%) compared to the prior art.

### SUMMARY OF INVENTION

The present invention provides a method, system and plant for producing ammonia with a high percentage of carbon capture, preferably >98%, when compared to the standard method where optimally between about 90-93% of carbon capture is achieved.

The method of the present invention provides the following advantages:
Can be applied for grass root plants and as revamps
Utilize the already available CO₂ removal step in the ammonia process to perform the complete CO₂ capture;
Enables >98% CO₂ recovery;
Reduces the adiabatic flame temperature thus reducing the NOx formations and thereby the NOx emission to the atmosphere;

Said advantages are provided by a set of features, comprising:
Natural gas firing is reduced to be used for pilot burners;
Carbon depleted gases mainly H₂ and N₂ used as fuel for the fuel systems;
Off-gases containing more than 60% Methane and/or CO are redirected to the reforming section or to the desulfurization section as additional feed gas;

### DESCRIPTION OF THE INVENTION

Reducing CO₂ emission has become a bound task in the chemical industry. Production of ammonia using hydrocarbons as feedstock inevitably results in CO₂ formation which typically ends up in at least two CO₂ containing process streams, one almost pure CO₂ stream (1) extracted from the syngas cleaning section and one or more flue gas streams (2). The CO₂ stream (1) can be utilized for further chemical processing or stored. The CO₂ in the flue gas stream (2) needs to be recovered before it can find similar use. The flue gas recovery process has a high operating and capital cost. It is therefore an advantage to limit the CO₂ content in the flue gas.

It is well known that CO₂ in the flue gas can be avoided by using carbon free fuels. In general hydrocarbons such as natural gas and carbon containing off gases originating from the process are used as fuels. The advantage of this invention is that the main part of these fuels are replaced by an internal hydrogen rich stream and that the unavoidable off gas are recycled to the process. By applying this invention it is possible to reduce the CO₂ content in the flue gas streams by more than 90%. Provided the pure CO₂ stream (1) is utilized or stored, then the product ammonia will be considered to be blue.

### Definitions

Blue Ammonia is ammonia that is created from using fossil fuel where at least 90% of the Carbon in the fossil fuel is captured to be used in other products and processes or to be stored.

Contaminant means any substances or elements which are not desirable. Within the context of the present invention, contaminants comprise catalyst poisons.

Flash gas means an intermediate gas stream obtained during desorption of CO₂ in a solvent based CO₂ removal step.

Green Ammonia is ammonia that is produced by using green electricity, water and air.

Green Electricity is electricity produced from renewable resources such as wind, solar, Hydro or geothermal energy

Fuel systems comprise fuel systems for supply of fuel to the combustion side of tubular reformers and/or fired heaters and/or auxiliary boilers and/or gas turbines. These systems comprise one or more burners in which the incoming fuel streams are burned together with air at variable temperature and pressure.

High-pressure electrolysis (HPE) is the electrolysis of water by decomposition of water (H₂O) into oxygen (O₂) and hydrogen gas (H₂) due to the passing of an electric current through the water at elevated pressure, typically above 10 bar.

PSA means pressure swing adsorption.

### PREFERRED EMBODIMENTS

1. Process for producing ammonia comprising the steps of:
a) preheating a hydrocarbon feed in a fuel system;
b) removing sulphur and other contaminants from the preheated hydrocarbon feed;
c) reforming the preheated hydrocarbon feed from step b) and obtaining a synthesis gas comprising CO, CO₂, H₂, H₂O and CH₄;
d) sending the synthesis gas from step c) through a shift reaction step reducing the CO content;
e) sending the gas from step d) to a CO₂ removal step where it is split in at least a CO₂ rich stream; and a hydrogen rich stream and optional a flash gas;
f) sending the hydrogen rich stream from step e) through:
i) a hydrogen purification and nitrogen wash, where H₂O, CO, CO₂, CH₄ are removed in an off-gas stream and obtaining a purified hydrogen stream and wherein nitrogen is added to obtain an ammonia synthesis gas stream comprising nitrogen and hydrogen; or
ii) a PSA, resulting in a hydrogen stream containing more than 99.5% hydrogen to which nitrogen is added to obtain a synthesis gas stream comprising nitrogen and hydrogen and an off-gas stream; or
iii) a methanation, converting the CO and CO₂ together with hydrogen into CH₄ and H₂O, to obtain a synthesis gas stream, comprising nitrogen, hydrogen and inerts comprising CH₄;
g) sending a part of the synthesis gas stream from step f) through an ammonia synthesis section, where it is converted to ammonia and another part of the synthesis gas stream to the preheating system;
wherein the preheating system comprise at least two or more separate fired heaters and wherein at least one of the fired heaters is equipped with a unit which removes 80% or more CO2 from the resulting flue gas and wherein said fired heater is using the off-gasses from step step f) and the flash-gas from step e) and off gases in case of f) iii) from step g) as fuel.

2. Process according to embodiment 1, wherein the reforming step c) is performed in an autothermal reformer or in a tubular reformer, followed by a step in an autothermal reformer or in a tubular reformer and followed by an air blown secondary reformer.

3. Process according to embodiment 1 or 2, wherein a hydrocarbon fuel, flash gas from step e), off-gas from step f) and part of the synthesis gas streams from step f) are either premixed or fed separately to the fuel system.

4. Process according to any of the preceding embodiments comprising an adiabatic pre-reforming step co) of the hydrocarbon stream from step b).

5. Process according to any one of the preceding embodiments wherein in step f) i) the hydrogen purification and nitrogen addition are performed by sending the hydrogen rich stream to a PSA, then nitrogen is added to the resulting hydrogen stream and at least part of the resulting off-gas stream is sent to the preheating in step a).

6. Process according to any one of the preceding embodiments, wherein in the methanation step f) iii) CO, CO₂ and hydrogen are converted to CH₄ and H₂O and wherein a purge gas stream, comprising the CH₄ from the ammonia synthesis, is added.

7. Process according to embodiment 8, wherein the CH₄ is captured from a stream of non-reacted components from the ammonia synthesis section in a hydrogen recovery unit resulting in a stream containing more than 99% hydrogen, which is sent to the ammonia synthesis section in step g) and/or the preheating system in step a), and an off-gas containing more than 95% of the CH₄ content in the synthesis gas stream into the ammonia synthesis section in step g), which is used as fuel in the one or more fired heaters equipped with a flue gas CO₂ removal unit.

8. Process according to embodiment 2, wherein the amount of air to the air blown secondary reformer is adjusted to obtain a molar ratio of N₂ and H₂ between 1 to 2.5 and 1 to 3.5, in the stream from the methanation in step f iii).

9. Process according to the preceding embodiments, wherein the synthesis gas stream obtained from step f) comprises N₂ and H₂ in a ratio of 1 to between 2.9 and 3.1.

10. System for producing ammonia according to the process in embodiments 1 to 9, comprising:
a) a preheating unit
b) a desulfurization unit;
c) a reforming unit;
d) a shift unit;
e) a CO₂ removal unit;
f) a nitrogen washing unit or a pressure swing adsorption unit or a methanation unit,
g) an ammonia synthesis section; and
h) fuel systems which supply fuel to at least two or more separate heaters in the preheating unit and wherein at least one heater is equipped with a unit which removes 80% or more CO₂ from the resulting flue gas.

11. System according embodiment 10, wherein a pre-reforming unit is arranged upstream to the reforming unit c).

12. System according to embodiment 10 or 11 wherein the reforming unit c) comprises an autothermal reformer or a tubular reformer followed by an autothermal reformer or a tubular reformer followed by an air blown secondary reformer.

13. System according to embodiment 10 or 11, wherein the reforming unit c) comprises an autothermal reformer and f) is a CO₂ and H₂O drier followed by a nitrogen wash unit.

14. System according to embodiment 10 or 11, wherein the reforming unit c) comprises an autothermal reformer and f) is a PSA.

15. System according to embodiment 10 or 11, wherein the reforming unit c) comprises a tubular steam reformer followed by an autothermal reformer and f) is a CO₂ and H₂O drier followed by a nitrogen wash.

16. System according to embodiment 10 or 11, wherein the reforming unit c) comprises a tubular steam reformer followed by an autothermal reformer and f) is a PSA.

17. System according to embodiment 10 or 11, wherein the reforming unit c) comprises a tubular steam reformer followed by an air blown secondary reformer and f) is a methanation unit.

### BRIEF DESCRIPTION OF DRAWINGS

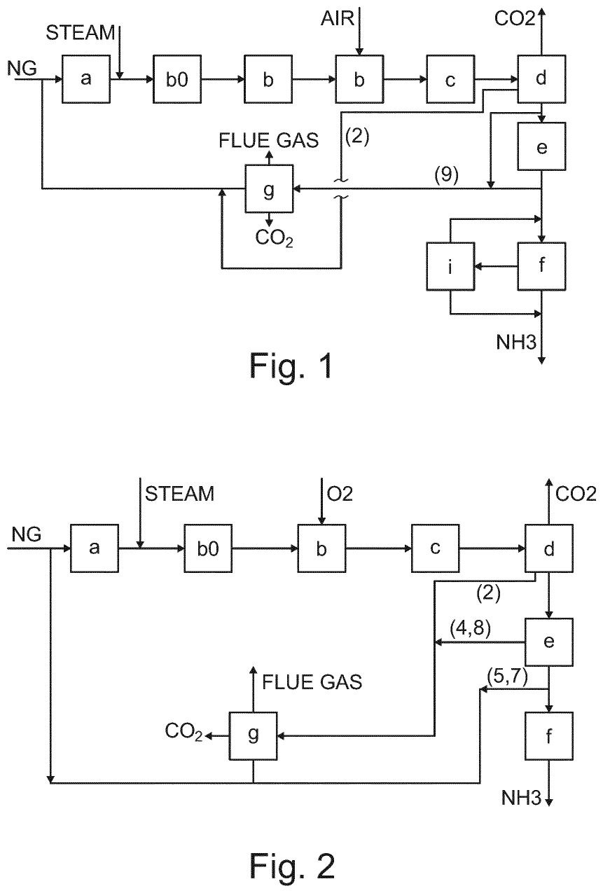

FIG. 1 shows an overview for producing ammonia according to a state of the art method.
a) Desulphurization
b₀) Pre-reforming
b) Reforming (SMR)
b) Secondary reformer (air blown ATR)
c) Shift section
d) CO₂ removal section
e) Methanation
f) Ammonia synthesis
g) Fuel system(s)
i) Ammonia recovery
Stream (9). Hydrogen rich fuel comprising nitrogen (replacing use of natural gas as fuel) Stream (2) Flash gas from CO₂ removal

FIG. 2 shows an overview of a method to produce Ammonia using Topsoe SynCOR Ammonia™ process”:
a) Desulphurization
b₀) Pre-reforming
b) Reforming (ATR)
c) Shift section
d) CO₂ Removal
e) Nitrogen wash or PSA
f) Ammonia synthesis
g) Fuel system(s)
Stream (4,8). Recycle off-gas stream.
Stream (5,7). Hydrogen rich fuel comprising nitrogen (replacing use of natural gas as fuel)
Stream 2. Flash gas from CO₂ removal

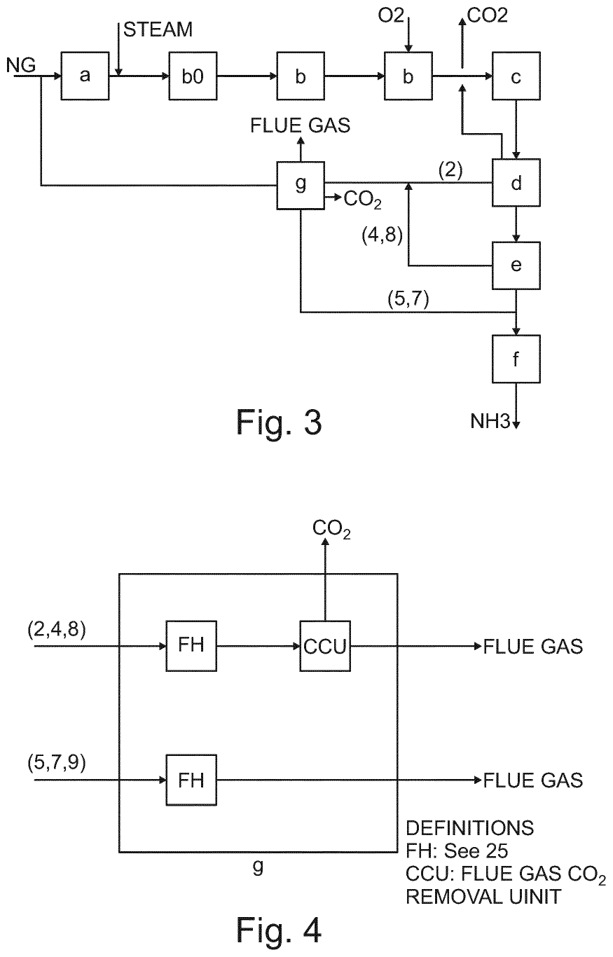

FIG. 3 shows an overview for producing ammonia using a steam reformer followed by an autothermal reformer in the synthesis gas generation:
a) Desulphurization
b) Pre-reforming
b) Reforming (SMR)
b) Reforming (ATR)
c) Shift section
d) CO₂ removal
e) Nitrogen wash or PSA
f) Ammonia synthesis
g) Fuel system(s)
Stream (4,8). Recycle off-gas stream.
Stream (5,7). Hydrogen rich fuel comprising nitrogen (replacing use of natural gas as fuel)
Stream (2). Flash gas from CO₂ removal

FIG. 4 is an exploded view of the fuel system(s) g):
FH) Fired heater
CCU) Flue gas carbon capture unit
Stream (2,4,8) Flash gas from CO₂ removal in unit d) and recycle off-gas stream from unit e)
Stream (5,7,9) hydrogen rich fuel comprising nitrogen split stream

References used to represent the different steps of in the method of the present invention are:
a) Desulphurization
b₀) Pre-reforming
b) Reforming (SMR)
b) Reforming (ATR)
b) Reforming (Air blown secondary reformer)
c) Shift
d) CO₂ Removal
e) Nitrogen wash or PSA or Methanation
f) Ammonia synthesis
g) Fuel system(s)
i) Ammonia recovery
Stream (4,8,10): Recycle off-gas stream.
Stream (9): Hydrogen rich fuel (replacing use of natural gas as fuel)
Stream (5,7): Hydrogen rich fuel (replacing use of natural gas as fuel)
Stream (2): Flash gas from CO₂ removal

### Example 1

Table 1 shows the benefits of the proposed layout in the present invention, in terms of carbon recovery (%).

Traditional ammonia production involves utilization of off gases from ammonia recovery and syngas preparation steps to supplement natural gas as main fuels for fired heater/process furnaces. This would result in carbon emissions from flue gas stack which could partly be recovered by using a solution based carbon capture technology. The recovery rate for such a plant, including carbon recovery from flue gases would not be higher than 90% and is a capital intensive process. With the proposed layout including firing of hydrogen rich fuel and utilization of off gases in the main process results in significant carbon emission reduction, more than 98% recovery. This process will be significantly cheaper and would require minimum steps and will have lower footprint on plot. Better than 99% recovery can be obtained by recycling at least part of streams (4,8) to the reforming step b

TABLE 1

| | Syncor Ammonia | Proposed layout: |
|---|---|---|
| | (existing process) | Blue Ammonia |
| Ammonia production, MTPD | 3500 | 3500 |
| CO₂ in Flue gas, Nm³/h | 26,200 | 2030 |
| CO₂ as 100%, captured for | 98000 | 130100 |
| storage/utilization, Nm³/h | | |
| Carbon recovery, %, approx | 80 | >98 |

1. Process for producing ammonia comprising the steps of:
a) preheating a hydrocarbon feed in a fuel system;
b) removing sulphur and other contaminants from the preheated hydrocarbon feed;
c) reforming the preheated hydrocarbon feed from step b) and obtaining a synthesis gas comprising CO, CO₂, H₂, H₂O and CH₄;
d) sending the synthesis gas from step c) through a shift reaction step reducing the CO content;
e) sending the gas from step d) to a CO₂ removal step where it is split in at least a CO₂ rich stream; and a hydrogen rich stream and optional a flash gas;
f) sending the hydrogen rich stream from step e) through:
i) a hydrogen purification and nitrogen wash, where H₂O, CO, CO₂, CH₄ are removed in an off-gas stream and obtaining a purified hydrogen stream and wherein nitrogen is added to obtain an ammonia synthesis gas stream comprising nitrogen and hydrogen; or
ii) a PSA, resulting in a hydrogen stream containing more than 99.5% hydrogen to which nitrogen is added to obtain a synthesis gas stream comprising nitrogen and hydrogen and an off-gas stream; or
iii) a methanation, converting the CO and CO₂ together with hydrogen into CH₄ and H₂O, to obtain a synthesis gas stream, comprising nitrogen, hydrogen and inerts comprising CH₄;
g) sending a part of the synthesis gas stream from step f) through an ammonia synthesis section, where it is converted to ammonia and another part of the synthesis gas stream to the preheating system;
wherein the fuel system comprises at least two or more separate fired heaters and wherein at least one of the fired heaters is equipped with a unit which removes 80% or more CO₂ from the resulting flue gas and wherein said fired heater is using the off-gasses from step f) and the flash-gas from step e) and off gases in case of f) iii) from step g) as fuel.

2. Process according to claim 1, wherein the reforming step c) is performed in an autothermal reformer or in a tubular reformer, followed by a step in an autothermal reformer or in a tubular reformer and followed by an air blown secondary reformer.

3. Process according to claim 1, wherein a hydrocarbon fuel, flash gas from step e), off-gas from step f) and part of the synthesis gas streams from step f) are either premixed or fed separately to the fuel system.

4. Process according to claim 1, comprising an adiabatic pre-reforming step co) of the hydrocarbon stream from step b).

5. Process according to claim 1, wherein in step f) i) the hydrogen purification and nitrogen addition are performed by sending the hydrogen rich stream to a PSA, then nitrogen is added to the resulting hydrogen stream and at least part of the resulting off-gas stream is sent to the preheating in step a).

6. Process according to claim 1, wherein in the methanation step f) iii) CO, CO₂ and hydrogen are converted to CH₄ and H₂O and wherein a purge gas stream, comprising the CH₄ from the ammonia synthesis, is added.

7. Process according to claim 6, wherein the CH₄ is captured from a stream of non-reacted components from the ammonia synthesis section in a hydrogen recovery unit resulting in a stream containing more than 99% hydrogen, which is sent to the ammonia synthesis section in step g) and/or the preheating system in step a), and an off-gas containing more than 95% of the CH₄ content in the synthesis gas stream into the ammonia synthesis section in step g), which is used as fuel in the one or more fired heaters equipped with a flue gas CO₂ removal unit.

8. Process according to claim 2, wherein the amount of air to the air blown secondary reformer is adjusted to obtain a molar ratio of N₂ and H₂ between 1 to 2.5 and 1 to 3.5, in the stream from the methanation in step f iii).

9. Process according to claim 1, wherein the synthesis gas stream obtained from step f) comprises N₂ and H₂ in a ratio of 1 to between 2.9 and 3.1.

10. System for producing ammonia according to the process in claim 1, comprising:
a) a preheating unit
b) a desulfurization unit;
c) a reforming unit;
d) a shift unit;
e) a CO₂ removal unit;
f) a nitrogen washing unit or a pressure swing adsorption unit or a methanation unit,
g) an ammonia synthesis section; and
h) fuel system(s) which supplies fuel to at least two or more separate heaters in the preheating unit and wherein at least one heater is equipped with a unit which removes 80% or more CO₂ from the resulting flue gas.

11. System according claim 10, wherein a pre-reforming unit is arranged upstream to the reforming unit c).

12. System according to claim 10, wherein the reforming unit c) comprises an autothermal reformer or a tubular reformer followed by an autothermal reformer or a tubular reformer followed by an air blown secondary reformer.

13. System according to claim 10, wherein the reforming unit c) comprises an autothermal reformer and f) is a CO₂ and H₂O drier followed by a nitrogen wash unit.

14. System according to claim 10, wherein the reforming unit c) comprises an autothermal reformer and f) is a PSA.

15. System according to claim 10, wherein the reforming unit c) comprises a tubular steam reformer followed by an autothermal reformer and f) is a CO₂ and H₂O drier followed by a nitrogen wash.

16. System according to claim 10, wherein the reforming unit c) comprises a tubular steam reformer followed by an autothermal reformer and f) is a PSA.

17. System according to claim 10, wherein the reforming unit c) comprises a tubular steam reformer followed by an air blown secondary reformer and f) is a methanation unit.
